(19) United States
(12) Patent Application Publication
(10) Pub. No.: US 2025/0050216 A1
(43) Pub. Date: Feb. 13, 2025

(54) METHOD AND APPARATUS FOR CONTROLLING VIRTUAL PROP, DEVICE, AND STORAGE MEDIUM

(71) Applicant: TENCENT TECHNOLOGY (SHENZHEN) COMPANY LIMITED, Shenzhen (CN)

(72) Inventor: Zhihong LIU, Shenzhen (CN)

(21) Appl. No.: 18/928,143

(22) Filed: Oct. 27, 2024

Related U.S. Application Data
(63) Continuation of application No. PCT/CN2023/121301, filed on Sep. 26, 2023.

(30) Foreign Application Priority Data
Nov. 7, 2022 (CN) 202211384828.2

(51) Int. Cl. A63F 13/56; A63F 13/533; A63F 13/537; A63F 13/92

(52) U.S. Cl. CPC A63F 13/56; A63F 13/533; A63F 13/537; A63F 13/92; A63F 2300/308

(57) ABSTRACT

A control method includes displaying a game interface configured to carry a virtual environment in which a virtual operation object is located and including a virtual prop selection control set, controlling, in response to a first operation on a first target virtual prop selection control in the virtual prop selection control set, the virtual operation object to be equipped with a first target virtual prop corresponding to the first target virtual prop selection control, and controlling, in response to a second operation on a second target virtual prop selection control in the virtual prop selection control set, the virtual operation object to throw a second target virtual prop corresponding to the second target virtual prop selection control. An equipping operation on the first target virtual prop and a throwing operation on the second target virtual prop are implemented using different parts of the virtual operation object.

### CROSS-REFERENCE TO RELATED APPLICATIONS

This application is a continuation of International Application No. PCT/CN2023/121301, which claims priority to Chinese Patent Application No. 202211384828.2, entitled “METHOD AND APPARATUS FOR CONTROLLING VIRTUAL PROP, DEVICE, AND STORAGE MEDIUM” filed with the China National Intellectual Property Administration on Nov. 7, 2022, which are incorporated by reference in their entirety.

### FIELD OF THE TECHNOLOGY

This application relates to the field of computers, and in particular, to a technology for controlling a virtual prop.

### BACKGROUND OF THE DISCLOSURE

A battle game is a game in which a plurality of user accounts compete in a same scene. A player may control a virtual operation object in a virtual environment to perform an action such as walking, running, climbing, or shooting, and a plurality of players may team up online to collaboratively complete a specified task in a same virtual environment.

During the game, when the player controls the virtual operation object to operate a virtual prop, the player generally can control the virtual operation object to operate the virtual prop by using only a right hand thereof, for example, control the virtual operation object to operate a virtual attack prop by using the right hand, or control the virtual operation object to throw a virtual throwing object by using the right hand. In other words, currently, during the game, an operation mode of the virtual prop is single, and when a user needs to control the virtual operation object to switch the virtual prop, the user needs to first enable the virtual operation object to drop the virtual prop currently held by the right hand and then exchange the virtual prop for another virtual prop, which takes a long time.

### SUMMARY

In accordance with the disclosure, there is provided a control method including displaying a game interface configured to carry a virtual environment in which a virtual operation object is located and including a virtual prop selection control set, controlling, in response to a first operation on a first target virtual prop selection control in the virtual prop selection control set, the virtual operation object to be equipped with a first target virtual prop corresponding to the first target virtual prop selection control, and controlling, in response to a second operation on a second target virtual prop selection control in the virtual prop selection control set, the virtual operation object to throw a second target virtual prop corresponding to the second target virtual prop selection control. An equipping operation on the first target virtual prop and a throwing operation on the second target virtual prop are implemented using different parts of the virtual operation object.

Also in accordance with the disclosure, there is provided a computer device including at least one bus system, at least one memory storing one or more programs, and at least one processor connected to and communicating with the at least one memory through the at least one bus system, and configured to execute the one or more programs to display a game interface configured to carry a virtual environment in which a virtual operation object is located and including a virtual prop selection control set, control, in response to a first operation on a first target virtual prop selection control in the virtual prop selection control set, the virtual operation object to be equipped with a first target virtual prop corresponding to the first target virtual prop selection control, and control, in response to a second operation on a second target virtual prop selection control in the virtual prop selection control set, the virtual operation object to throw a second target virtual prop corresponding to the second target virtual prop selection control. An equipping operation on the first target virtual prop and a throwing operation on the second target virtual prop are implemented using different parts of the virtual operation object.

Also in accordance with the disclosure, there is provided a non-transitory computer-readable storage medium storing one or more instructions that, when run on a computer, cause the computer to display a game interface configured to carry a virtual environment in which a virtual operation object is located and including a virtual prop selection control set, control, in response to a first operation on a first target virtual prop selection control in the virtual prop selection control set, the virtual operation object to be equipped with a first target virtual prop corresponding to the first target virtual prop selection control, and control, in response to a second operation on a second target virtual prop selection control in the virtual prop selection control set, the virtual operation object to throw a second target virtual prop corresponding to the second target virtual prop selection control. An equipping operation on the first target virtual prop and a throwing operation on the second target virtual prop are implemented using different parts of the virtual operation object.

### BRIEF DESCRIPTION OF THE DRAWINGS

FIG. 1 is a schematic diagram showing an implementation environment of a method for controlling a virtual prop according to an embodiment of this application.

FIG. 2 is a schematic diagram showing an embodiment of a method for controlling a virtual prop according to an embodiment of this application.

FIG. 3 is a schematic diagram showing a virtual prop selection control set on a first game interface according to an embodiment of this application.

FIG. 4 is a schematic diagram showing an operation on a virtual prop selection control on a first game interface according to an embodiment of this application.

FIG. 5A is a schematic diagram showing an operation mode option control on a second game interface according to an embodiment of this application.

FIG. 5B is a schematic diagram showing throwing a dagger by using a left hand and equipping a right hand with a gun on a second game interface according to an embodiment of this application.

FIG. 6 is a schematic diagram showing an operation of throwing a dagger on a first game interface according to an embodiment of this application.

FIG. 7 is a schematic diagram showing another embodiment of a method for controlling a virtual prop according to an embodiment of this application.

FIG. 8 is a schematic diagram showing a setting option control on a third game interface according to an embodiment of this application.

FIG. 9 is a schematic diagram showing an embodiment of an apparatus for controlling a virtual prop according to an embodiment of this application.

FIG. 10 is a schematic diagram showing another embodiment of an apparatus for controlling a virtual prop according to an embodiment of this application.

FIG. 11 is a schematic diagram showing another embodiment of an apparatus for controlling a virtual prop according to an embodiment of this application.

FIG. 12 is a schematic diagram showing another embodiment of an apparatus for controlling a virtual prop according to an embodiment of this application.

FIG. 13 is a schematic diagram showing another embodiment of an apparatus for controlling a virtual prop according to an embodiment of this application.

FIG. 14 is a schematic diagram showing another embodiment of an apparatus for controlling a virtual prop according to an embodiment of this application.

FIG. 15 is a schematic diagram showing another embodiment of an apparatus for controlling a virtual prop according to an embodiment of this application.

### DESCRIPTION OF EMBODIMENTS

In the specification, claims, and the foregoing accompanying drawings of this application, the terms “first,” “second,” “third,” “fourth,” and the like (if any) are configured for distinguishing between similar objects and are not necessarily configured for describing a particular order or sequence. Data used in this way is interchangeable in a suitable case, so that embodiments of this application described herein can, for example, be implemented in an order other than those illustrated or described herein. In addition, the terms “comprise,” “corresponding to,” and any other variants are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

To resolve technical problems such as a single operation mode of a game virtual prop and large time consumption required when a user controls a virtual operation object to switch a virtual prop in the related art, this application provides a technical solution as follows: displaying a first game interface, the first game interface being configured to carry a virtual environment in which a first virtual operation object is located, the first game interface including a virtual prop selection control set, and the virtual prop selection control set including virtual prop selection controls respectively corresponding to virtual props carried by the first virtual operation object; controlling, in response to a first operation on a first target virtual prop selection control in the virtual prop selection control set, the first virtual operation object to be equipped with a first target virtual prop corresponding to the first target virtual prop selection control; and controlling, in response to a second operation on a second target virtual prop selection control in the virtual prop selection control set, the first virtual operation object to throw a second target virtual prop corresponding to the second target virtual prop selection control, an equipping operation on the first target virtual prop and a throwing operation on the second target virtual prop being implemented by using different parts of the first virtual operation object, for example, by using a right hand and a left hand of the first virtual operation object respectively.

In this way, during a game operation, the virtual operation object is supported in controlling the virtual prop by using different parts of the virtual operation object. In this way, a manner for controlling the virtual prop is enriched. To be specific, the manner for controlling the virtual prop is no longer limited to controlling the virtual prop by using a right hand of the virtual operation object, and the virtual prop may alternatively be controlled by using another part (for example, a left hand) of the virtual operation object. In addition, in a case that the manner for controlling the virtual prop is no longer limited to controlling the virtual prop by using the right hand of the virtual operation object, the user may directly control another virtual prop by using another part of the virtual operation object without performing a switching operation on the virtual prop. For example, in a case that the virtual operation object holds a virtual attack prop on the right hand, the user may control the virtual operation object to throw another virtual prop by using the left hand of the virtual operation object, thereby reducing time consumption of a related operation.

The following describes some terms involved in this application.

Virtual environment: It is a virtual environment displayed (or provided) when an application runs on a terminal. The virtual environment may be a simulated environment corresponding to a real world, or may be a semi-simulated and semi-fictional environment, or may be a completely fictional environment. The virtual environment may be any one of a two-dimensional virtual environment, a 2.5-dimensional virtual environment, and a three-dimensional virtual environment. This is not limited in this application. The following embodiments are described by using an example in which the virtual environment is a three-dimensional virtual environment.

Virtual operation object: It is a movable object in a virtual environment. The movable object may be a virtual character, a virtual animal, a cartoon character, or the like, for example, a character or an animal displayed in a three-dimensional virtual environment. In some embodiments, the virtual operation object is a three-dimensional model created based on a skeletal animation technology. Each virtual operation object has a shape and size in the three-dimensional virtual environment, and occupies some space in the three-dimensional virtual environment.

Shooting game: It includes a first-person shooting game and a third-person shooting game. The first-person shooting game is a shooting game played by a user from a first-person perspective. A virtual environment picture in the game is a picture of observing a virtual environment from a perspective of a first virtual operation object operated by the user. The third-person shooting game is a shooting game played from a third-person perspective. A virtual environment picture in the game is a picture of observing a virtual environment from the third-person perspective (for example, located behind a head of the first virtual operation object operated by the user).

In the game, at least two virtual operation objects play a single-round battle in the virtual environment. The virtual operation object escapes a damage caused by another virtual operation object and a danger in the virtual environment, to survive in the virtual environment. When a hit point of the virtual operation object in the virtual environment is zero, life of the virtual operation object in the virtual environment ends, and a final virtual operation object surviving in the virtual environment wins. In some embodiments, the battle starts with a moment when a first client joins the battle, and ends with a moment when a last client exits the battle. Each client may control one or more virtual operation objects in the virtual environment. In some embodiments, arena modes of the battle may include a single-player battle mode, a two-player team battle mode, or a multi-player team battle mode. The battle mode is not limited in the embodiments of this application.

Virtual prop: It is a prop that can be used by a virtual operation object in a virtual environment, and includes an attack prop that can change an attribute value of another virtual operation object, a supply prop, a defensive prop, or a virtual prop displayed by using a hand when the virtual operation object casts a skill. The virtual prop that can change the attribute value of the another virtual operation object includes a long-distance virtual prop, a short-distance virtual prop, a throwing-type virtual prop, or the like.

The method provided in this application may be applied to a virtual reality application, a three-dimensional map program, a first/third-person shooting game, a multiplayer online battle arena game (MOBA), and the like. Application in a game is used as an example for description in the following embodiments.

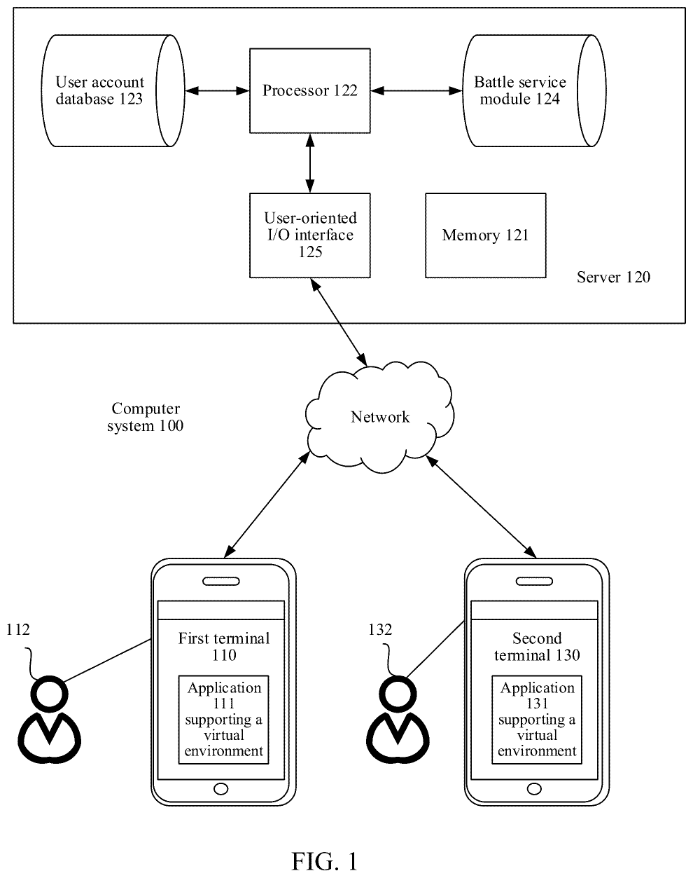

FIG. 1 is a schematic diagram showing an implementation environment according to an embodiment of this application. The implementation environment may include: a first terminal 110, a server 120, and a second terminal 130.

An application 111 supporting a virtual environment is installed and run on the first terminal 110, and the application 111 may be a multiplayer online battle program. When the first terminal runs the application 111, a user interface of the application 111 is displayed on a screen of the first terminal 110. The application 111 may be any one of a MOBA game, a battle royale shooting game, and a simulation game (SLG). In this embodiment, an example in which the application 111 is a first-person shooting (FPS) game is used for description. The first terminal 110 is a terminal used by a first user 112. The first user 112 uses the first terminal 110 to control a first virtual operation object located in the virtual environment to perform an activity, and the first virtual operation object may be referred to as a main control virtual operation object of the first user 112. The activity of the first virtual operation object includes, but is not limited to: at least one of adjusting a body posture, crawling, walking, running, riding, flying, jumping, driving, picking, shooting, attacking, throwing, and casting a skill. For example, the first virtual operation object is a first virtual character such as a simulated character or a cartoon character.

An application 131 supporting the virtual environment is installed and run on the second terminal 130, and the application 131 may be the multiplayer online battle program. When the second terminal 130 runs the application 131, a user interface of the application 131 is displayed on a screen of the second terminal 130. The application 131 may be any one of the MOBA game, a shooting game, and the SLG game. In this embodiment, an example in which the application 131 is the FPS game is used for description. The second terminal 130 is a terminal used by a second user 132. The second user 132 uses the second terminal 130 to control a second virtual operation object located in the virtual environment to perform an activity, and the second virtual operation object may be referred to as a main control virtual operation object of the second user 132. For example, the second virtual operation object is a second virtual character, such as a simulated character or a cartoon character.

In some embodiments, the first virtual operation object and the second virtual operation object are located in a same virtual world. In some embodiments, the first virtual operation object and the second virtual operation object may belong to a same camp, a same team, or a same organization, or have a friend relationship with each other or have a temporary communication permission. In some embodiments, the first virtual operation object and the second virtual operation object may belong to different camps, different teams, or different organizations, or have a hostile relationship with each other.

In some embodiments, the applications installed on the first terminal 110 and the second terminal 130 are the same, or the applications installed on the first terminal 110 and the second terminal 130 are a same type of applications on different operating system platforms (Android or iOS). The first terminal 110 may generally refer to one of a plurality of terminals, and the second terminal 130 may generally refer to another one of the plurality of terminals. In this embodiment, the first terminal 110 and the second terminal 130 are merely used as an example for description. Device types of the first terminal 110 and the second terminal 130 are the same or different. The device type includes a smartphone, a tablet computer, an e-book reader, a moving picture experts group audio layer III (MP3) player, a moving picture experts group audio layer IV (MP4) player, a laptop portable computer, a desktop computer, a notebook computer, a palmtop computer, a personal computer, a smart television, a smart watch, an in-vehicle device, a wearable device, a virtual reality (VR) device, an augmented reality (AR) device, and the like.

FIG. 1 shows only two terminals. However, a plurality of other terminals may access the server 120 in different embodiments. In some embodiments, one or more terminals are terminals corresponding to a developer. A developing and editing platform for the application supporting the virtual environment is installed on the terminal. The developer may edit and update the application on the terminal and transmit an updated application installation package to the server 120 through a wired or wireless network. The first terminal 110 and the second terminal 130 may download the application installation package from the server 120 to update the application.

The first terminal 110, the second terminal 130, and the another terminal are connected to the server 120 through the wireless network or the wired network.

The server 120 may be an independent physical server, or may be a server cluster or a distributed system formed by a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The server 120 is configured to provide a backend service for the application supporting the virtual environment. In some embodiments, the server 120 is responsible for primary computing work, and the terminal is responsible for secondary computing work; or the server 120 is responsible for secondary computing work, and the terminal is responsible for primary computing work; or a distributed computing architecture is used between the server 120 and the terminal to perform collaborative computing.

In an exemplary example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the other terminals, for example, avatars of the user accounts, nicknames of the user accounts, levels of the user accounts, and service zones of the user accounts. The battle service module 124 is configured to provide a plurality of battle rooms for the users to perform battles, for example, a 1V1 battle, a 3V3 battle, and a 5V5 battle. The user-oriented I/O interface 125 is configured to establish communication and exchange data with the first terminal 110 and/or the second terminal 130 through the wireless network or the wired network.

In a specific implementation of this application, related data such as game data is involved. When the foregoing embodiments of this application are applied to a specific product or technology, user permission or consent is required to be obtained, and relevant collection, use, and processing of data are required to comply with relevant laws, regulations, and standards of relevant countries and regions.

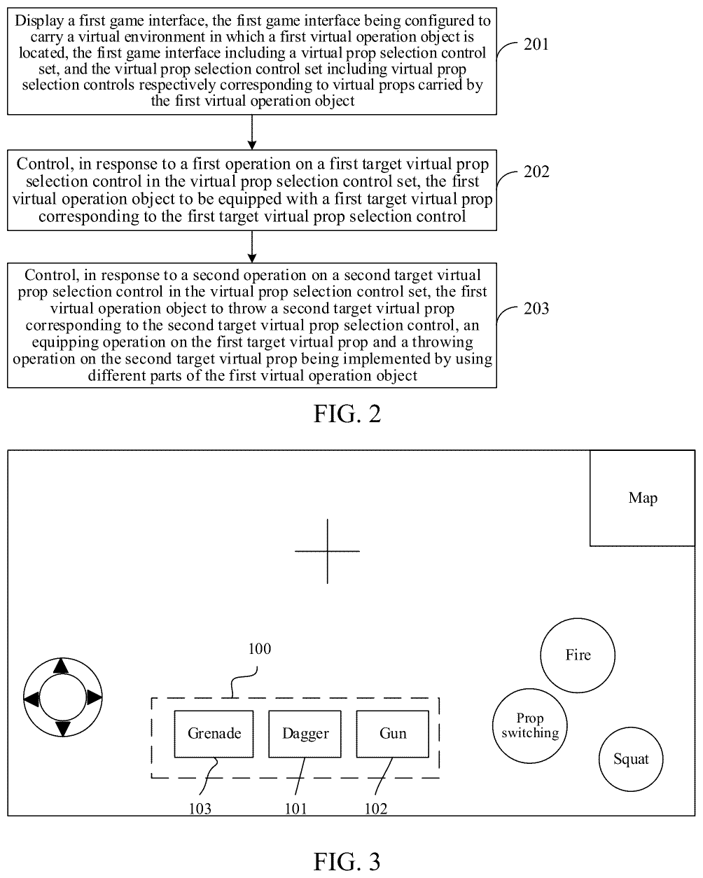

With reference to the foregoing descriptions, a method for controlling a virtual prop in this embodiment is described below by using an example in which the first terminal 110 or the second terminal 130 in the implementation environment shown in FIG. 1 or another terminal in the implementation environment is used as an execution body. Referring to FIG. 2, an embodiment of the method for controlling a virtual prop in this embodiment of this application includes the following operations.

201: Display a first game interface, the first game interface being configured to carry a virtual environment in which the first virtual operation object is located, the first game interface including a virtual prop selection control set, and the virtual prop selection control set including virtual prop selection controls respectively corresponding to virtual props carried by the first virtual operation object.

The method in this embodiment of this application is applied to the virtual environment. The virtual environment includes the first virtual operation object and the second virtual operation object. The first virtual operation object and the second virtual operation object may belong to different camps. In a possible implementation, the terminal displays the virtual environment through a virtual environment picture. In some embodiments, the virtual environment picture is a picture of observing the virtual environment from a perspective of the virtual operation object. The first game interface in this embodiment of this application is a virtual environment picture of observing the virtual environment from a perspective of the first virtual operation object. The perspective is an observation angle for observation from a first-person perspective or a third-person perspective of the virtual operation object in the virtual environment. In some embodiments, in this embodiment of this application, the perspective is an angle for observing the virtual environment by using a camera model in the virtual environment.

In some embodiments, the camera model automatically follows the virtual operation object in the virtual environment. To be specific, when a location of the virtual operation object in the virtual environment changes, a location of the camera model following the change of the location of the virtual operation object in the virtual environment changes simultaneously, and the camera model is always within a preset distance range from the virtual operation object in the virtual environment. In some embodiments, in the automatic following process, relative locations of the camera model and the virtual operation object remain unchanged.

The camera model is a three-dimensional model located around the virtual operation object in the virtual environment. When the first-person perspective is used, the camera model may be located near a head of the virtual operation object or located at the head of the virtual operation object. When the third-person perspective is used, the camera model may be located behind the virtual operation object and bound to the virtual operation object, or may be located at any location away from the virtual operation object by a preset distance. The virtual operation object located in the virtual environment may be observed from different angles by using the camera model. In some embodiments, when the third-person perspective is a first-person over-shoulder perspective, the camera model is located behind the virtual operation object (for example, a head and shoulders of a virtual character). In some embodiments, in addition to the first-person perspective and the third-person perspective, the perspective also includes another perspective, for example, a top-down perspective. When the top-down perspective is used, the camera model may be located above the head of the virtual operation object. The top-down perspective is a perspective for observing the virtual environment at an angle from the air. In some embodiments, the camera model is not actually displayed in the virtual environment. In other words, the camera model is not displayed in a virtual environment displayed on the user interface.

In this embodiment, the virtual prop selection control set is displayed on the first game interface (which may also be referred to as a virtual environment interface). The virtual prop selection control set includes the virtual prop selection controls respectively corresponding to the virtual props carried by the first virtual operation object. The virtual prop selection control is configured to control the first virtual operation object to use the corresponding virtual prop.

In an exemplary solution, as shown in FIG. 3, a virtual prop selection control set 100 is displayed on the first game interface. The virtual prop selection control set 100 may include a virtual prop selection control 101 corresponding to a virtual prop “dagger,” a virtual prop selection control 102 corresponding to a virtual prop “gun,” and a virtual prop selection control 103 corresponding to a virtual prop “grenade.” The virtual prop selection control 101 corresponding to the virtual prop “dagger” and the virtual prop selection control 102 corresponding to the virtual prop “gun” may be referred to as virtual attack prop selection controls in this embodiment, and the virtual prop selection control 103 corresponding to the virtual prop “grenade” may be referred to as a virtual throwing prop selection control in this embodiment.

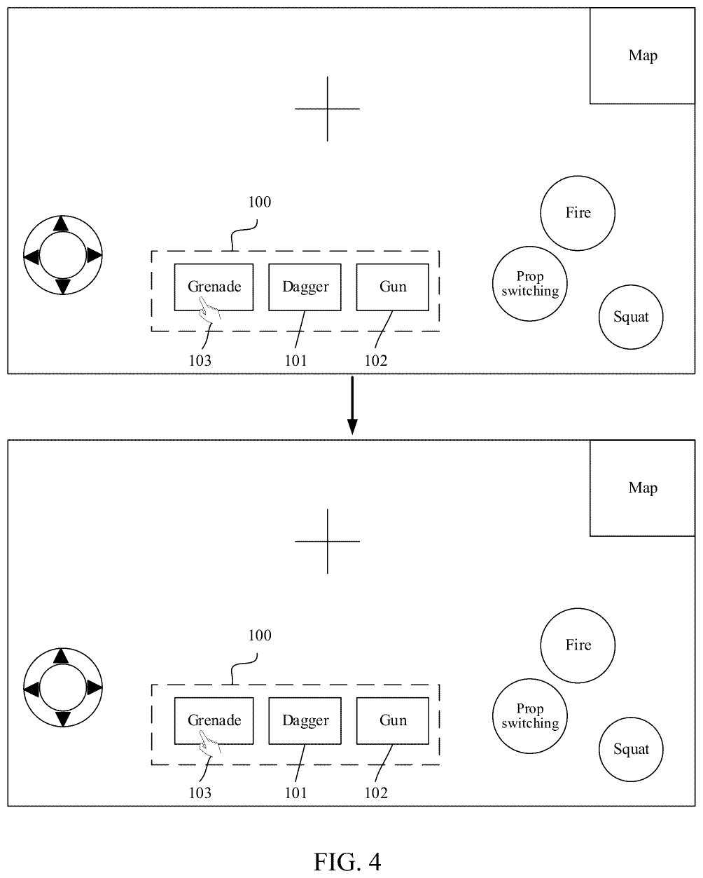

The virtual attack prop selection controls and the virtual throwing prop selection control may be switched. In a related technical solution, as shown in FIG. 4, the virtual prop selection control set 100 is displayed on the first game interface. The virtual prop selection control set 100 may include the virtual prop selection control 101 corresponding to the virtual prop “dagger,” the virtual prop selection control 102 corresponding to the virtual prop “gun,” and the virtual prop selection control 103 corresponding to the virtual prop “grenade.” Currently, the first virtual operation object is performing a shooting action. When a player taps on the virtual prop selection control 103, the terminal may switch the virtual prop “gun” currently used by the first virtual operation object to the virtual prop “grenade,” and display, on the first game interface, a picture of equipping the first virtual operation object with the “grenade.” This manner for switching the virtual prop generally takes a long time and is complex.

202: Control, in response to a first operation on a first target virtual prop selection control in the virtual prop selection control set, the first virtual operation object to be equipped with a first target virtual prop corresponding to the first target virtual prop selection control.

In a possible implementation, when receiving the first operation on the first target virtual prop selection control in the virtual prop selection control set, the terminal controls the first virtual operation object to switch the first target virtual prop to an equipping mode. In an exemplary solution, as shown in FIG. 3, the virtual prop selection control set 100 is displayed on the first game interface. The virtual prop selection control set 100 may include the virtual prop selection control 101 corresponding to the virtual prop “dagger,” the virtual prop selection control 102 corresponding to the virtual prop “gun,” and the virtual prop selection control 103 corresponding to the virtual prop “grenade.” If a first operation triggered for the virtual prop selection control 102 corresponding to the virtual prop “gun” is received, the first virtual operation object may be controlled to be equipped with the virtual prop “gun,” for example, the first virtual operation object is controlled to be equipped with the virtual prop “gun” on a right hand. In a case that the first virtual operation object is equipped with the virtual prop “gun,” if a first operation triggered for the virtual prop selection control 101 corresponding to the virtual prop “dagger” is received, the first virtual operation object may be controlled to switch to be equipped with the virtual prop “dagger,” that is, the first virtual operation object is controlled to be equipped with the virtual prop “dagger” on the right hand.

The first target virtual prop in this embodiment of this application may be any type of virtual prop that may be equipped with, for example, the virtual attack prop such as the gun or the dagger. Generally, the right hand of the first virtual operation object may be equipped with the first target virtual prop. If the equipping mode in this embodiment is to equip a left hand with the prop, when receiving the first operation on the first target virtual prop selection control, the terminal controls the first virtual operation object to be equipped with the first target virtual prop on the left hand. If the equipping mode in this embodiment is to equip the right hand with the prop, when receiving the first operation on the first target virtual prop selection control, the terminal controls the first virtual operation object to be equipped with the first target virtual prop on the right hand. A specific case is freely set by the user, and is not limited herein.

203: Control, in response to a second operation on a second target virtual prop selection control in the virtual prop selection control set, the first virtual operation object to throw a second target virtual prop corresponding to the second target virtual prop selection control, an equipping operation on the first target virtual prop and a throwing operation on the second target virtual prop being implemented by using different parts of the first virtual operation object.

In a possible implementation, when receiving the second operation on the second target virtual prop selection control in the virtual prop selection control set, the terminal controls the first virtual operation object to throw the second target virtual prop. During throwing, a throwing route of the second target virtual prop is displayed on the first game interface. The player may cause the throwing route of the second target virtual prop to be changed through different trigger operations on the second target virtual prop selection control, to throw the second target virtual prop to a target location in the virtual environment.

The second target virtual prop in this embodiment of this application may be any type of virtual prop that can be thrown, for example, the virtual attack prop such as the grenade or the dagger. In actual application, the first target virtual prop and the second target virtual prop may be the same virtual prop. For example, the virtual prop “dagger” supports both a near-body attack performed by the virtual operation object holding the virtual prop and a throw performed by the virtual operation object. Therefore, the virtual prop may serve as both the first target virtual prop and the second target virtual prop. Apparently, the first target virtual prop and the second target virtual prop may alternatively be different virtual props. For example, the first target virtual prop is the virtual prop “gun,” and the second target virtual prop is the virtual prop “dagger,” the virtual prop “grenade,” or the like.

In this embodiment of this application, a part used when the first virtual operation object throws the second target virtual prop is different from a part used when the first virtual operation object is equipped with the first target virtual prop. For example, in a case that the first virtual operation object is equipped with the first target virtual prop by using the right hand thereof, the first virtual operation object may be controlled to throw the second target virtual prop by using the left hand thereof. For another example, in a case that the first virtual operation object is equipped with the first target virtual prop by using the left hand thereof, the first virtual operation object may be controlled to throw the second target virtual prop by using the right hand thereof.

In some embodiments, the throwing route of the second target virtual prop may be determined based on an initial throwing speed, a throwing direction, and gravitational acceleration of the second target virtual prop. When the first virtual operation object is controlled to throw the second target virtual prop, the terminal obtains the initial speed and the direction of the second target virtual prop, and determines a ray trace of the second target virtual prop by using the gravitational acceleration. The terminal takes n points according to a fixed distance interval to form the ray trace, and displays the ray trace on the first game interface. In an exemplary solution, the foregoing ray trace includes a throwing parabola from a throwing starting-point location of the second target virtual prop to a throwing ending-point location of the second target virtual prop. The foregoing throwing starting-point location of the second target virtual prop is a location of the second target virtual prop, in other words, a location at which the first virtual operation object throws the second target virtual prop. The throwing ending-point location of the second target virtual prop is a predicted landing-point location of the second target virtual prop. Detection may be performed on a landing point based on an area of the throwing ending-point location of the second target virtual prop. When an area detection result indicates that the second target virtual prop can reach the area, a to-be-run trace of the second target virtual prop is displayed as the foregoing throwing parabola. When the area detection result indicates that the second target virtual prop cannot reach the area, the to-be-run trace of the second target virtual prop is displayed as a parabola from a current location to a farthest point reachable by the second target virtual prop. A shape of the foregoing throwing parabola may be determined by a distance between the throwing starting-point location of the second target virtual prop and the throwing ending-point location of the second target virtual prop. In other words, the shape of the throwing parabola is variable, and an arc thereof may be negatively correlated with the foregoing distance. To be specific, the longer the distance, the smaller the arc. Apparently, the shape of the foregoing throwing parabola may also be fixed, in other words, may be a curve with a fixed arc.

In this embodiment, while the throwing route is displayed, a prop identifier of the second target virtual prop may be further displayed at the target location on the first game interface. In addition, if the second target virtual prop hits the second virtual operation object in the virtual environment, a damage value for the second virtual operation object may be determined based on a hit location of the second target virtual prop on the second virtual operation object, and then a hit point of the second virtual operation object is reduced based on the damage value. For example, if a head or a heart is hit, the hit point of the second virtual operation object may be directly zeroed. If limbs are hit, the hit point of the second virtual operation object is reduced by ten percent.

Alternatively, it is directly set that the hit point of the second virtual operation object is directly zeroed as long as the second target virtual prop hits the second virtual operation object. A specific case is not limited herein as long as a hit effect can be achieved.

In some embodiments, when the first target virtual prop and the second target virtual prop are a same target virtual prop, to implement the equipping operation on the target virtual prop and the throwing operation on the target virtual prop through the corresponding target virtual prop selection control, the player may pre-configure, through a configuration interface, the target virtual prop selection control to have both a function of triggering the target virtual prop to be equipped with and a function of triggering the target virtual prop to be thrown.

In this case, the terminal may display a second game interface, the second game interface being a virtual prop setting interface corresponding to the first virtual operation object, the second game interface including an operation mode option control, and the operation mode option control being configured to indicate that the first virtual operation object has a left-hand throwing operation mode and a right-hand equipping mode for the target virtual prop; and configure, in response to a third operation on the operation mode option control, an operation mode of the target virtual prop to be the left-hand throwing operation mode and the right-hand equipping mode.

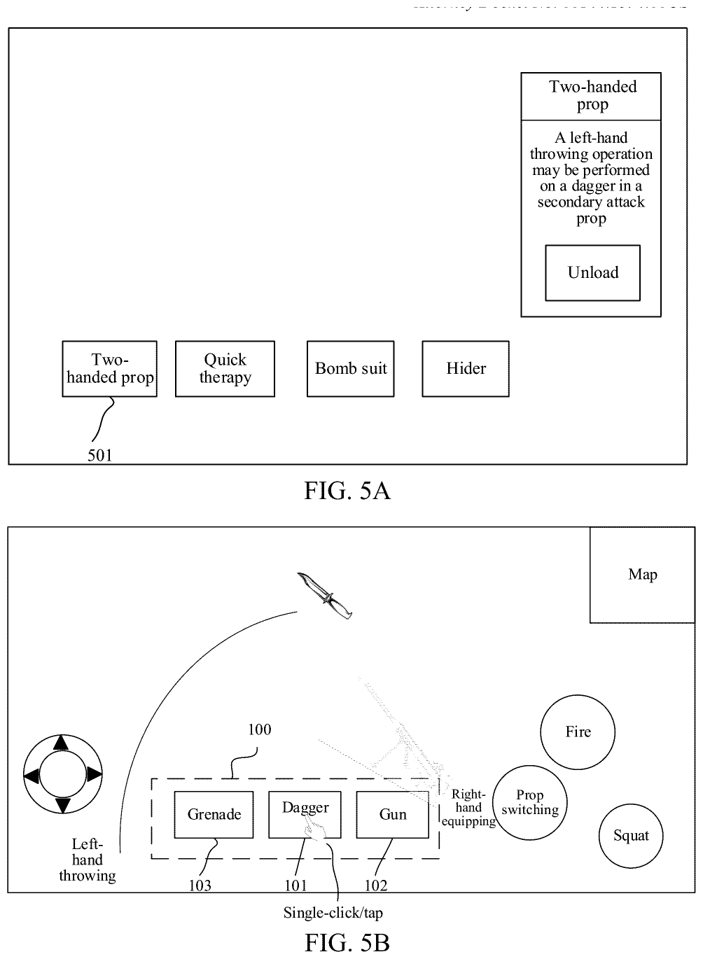

In an exemplary solution, the second game interface shown in FIG. 5A may include a plurality of operation mode option controls for setting the virtual prop. An operation mode option control 501 is an option control for setting a “two-handed prop.” After the operation mode option control 501 is clicked/tapped to select, a specific description of the operation mode option control may be displayed through a pop-up window. In the solution shown in FIG. 5A, the specific description of the operation mode option control 501 may be set to “a left-hand throwing operation may be performed on a dagger in a secondary attack prop.” After the operation mode option control 501 is clicked/tapped to select, the first virtual operation object may be controlled, through the first operation, to be equipped with the virtual prop “dagger” on the right hand, and the first virtual operation object may be controlled, through the second operation, to throw the virtual prop “dagger” by using the left hand (which is also referred to as a remote attack). If the operation mode option control 501 is not clicked/tapped to select, the terminal may only control the first virtual operation object to be equipped with the secondary attack prop “dagger” on the right hand to perform a near battle attack (for example, control the first virtual operation object to perform an action such as stabbing or chopping).

In some embodiments, in this embodiment, if the first virtual operation object is being equipped with a first target virtual attack prop on the right hand when the terminal receives the second operation, left-hand throwing of a second target virtual attack prop may be performed while continuously keeping the right hand equipped with the first target virtual attack prop, and there is no need to switch the first target virtual attack prop that the first virtual operation object is equipped with on the right hand. In an exemplary solution, the first game interface shown in FIG. 5B shows that the virtual prop “dagger” is thrown by using the left hand when the first virtual operation object is equipped with the virtual prop “gun” on the right hand.

FIG. 5A and FIG. 5B show only a scenario in which the first target virtual prop and the second target virtual prop are virtual attack props. In actual application, the first target virtual prop or the second target virtual prop may alternatively be a defensive prop or another prop. This is not specifically limited herein.

In this solution, a principle of controlling the first virtual operation object to perform corresponding actions by using the left hand and the right hand respectively may be as follows:

First, a template state machine needs to be established, and has the name because both a left-hand animation state machine and a right-hand animation state machine directly refer to the template state machine; and then two animations, namely, a left-hand animation and a right-hand animation, are respectively made, a full-body action state machine is responsible for playing an entire animation, and the left-hand animation state machine and the right-hand animation state machine are respectively responsible for separately playing the left-hand animation and the right-hand animation. Because each animation plays only a bone node bound to the animation, the left-hand animation state machine controls only a bone node of the left hand of the virtual operation object.

A basic idea of the state machine is to cause the virtual operation object to perform a specific action at a given moment. An action type may be different due to a different game type. A common action includes idling, walking, running, jumping, or the like. Each action is referred to as a state. Generally, a specific limit condition is required for a character to be immediately switched from a state to another state. For example, a character state can only be switched from a running state to a jumping state, but cannot be directly switched from a stationary state to a running and jumping state. The foregoing limit condition is referred to as a state transition condition. A state set, the state transition condition, and a variable recording a current state are put together to form a simplest state machine.

In some embodiments, in this embodiment, if the terminal is controlling the first virtual operation object to be equipped with the first target virtual prop on the left hand when receiving the second operation on the second target virtual prop selection control, the terminal may further perform right-hand throwing of the second target virtual prop while continuously keeping the first virtual operation object equipped with the first target virtual prop on the left hand, and there is no need to switch the virtual prop that the first virtual operation object is equipped with on the left hand.

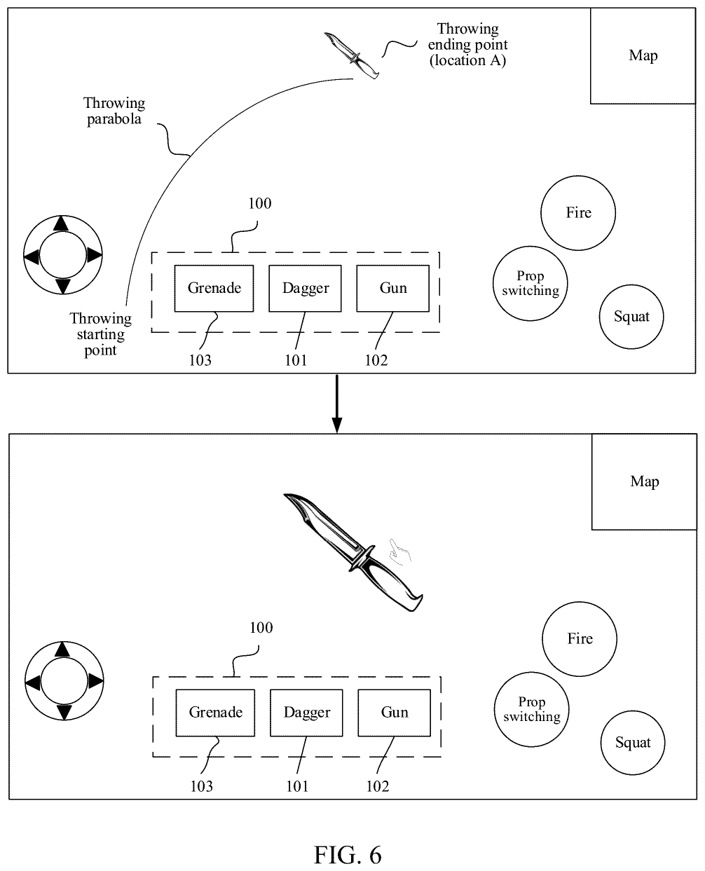

In some embodiments, in this embodiment, when the second target virtual prop is an attack prop or a defensive prop, after the terminal controls the first virtual operation object to throw the second target virtual prop, the second target virtual prop does not appear, and the prop identifier of the second target virtual prop may be displayed at a prop location of the second target virtual prop after the second target virtual prop is thrown. Then, the player may control the first virtual operation object to move near the prop location and reclaim the second target virtual prop by performing a corresponding operation on the prop identifier. In an exemplary solution, as shown in FIG. 6, the terminal controls the first virtual operation object to throw the virtual prop “dagger” to a location A. Then, the terminal controls the first virtual operation object to move near the location A, and then clicks/taps to select an icon identifier corresponding to the virtual prop “dagger,” to pick up the virtual prop “dagger.”

In some embodiments, in this embodiment, when the first target virtual prop and the second target virtual prop are the same target virtual prop, because both the first operation and the second operation are performed on the target virtual prop selection control corresponding to the target virtual prop, to implement different operation modes, it is necessary to set a difference between the first operation and the second operation. In an exemplary solution, the first operation is a single click/tap, and the second operation is a double click/tap; the first operation is a single-click/tap operation, and the second operation is a long press for more than 2 seconds; the first operation is a double click/tap for once, and the second operation is a double click/tap for twice; or the like. This is not specifically limited herein as long as the difference between the first operation and the second operation can be implemented.

In this embodiment, a time sequence between operation 202 and operation 203 is not limited. Operation 202 may be performed before operation 203; or operation 203 may be performed before 202.

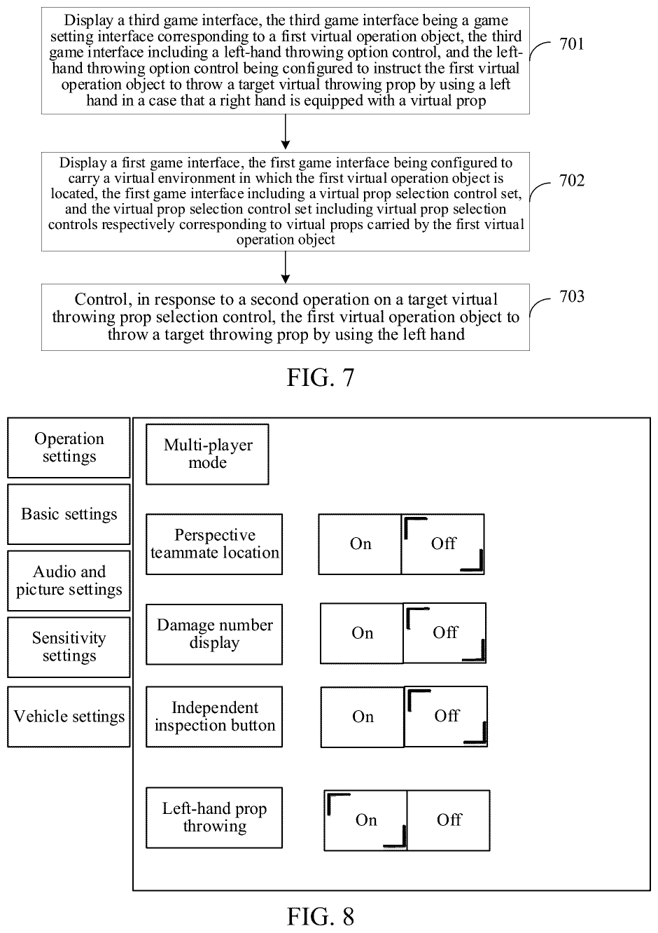

A throwing solution and an equipping solution of the virtual prop are described above. The following embodiments may further provide a method for controlling a virtual prop. The following describes the method for controlling a virtual prop in this application by using an example in which the first terminal 110 or the second terminal 130 in the implementation environment shown in FIG. 1 or another terminal in the implementation environment is used as an execution body. Referring to FIG. 7, an embodiment of the method for controlling a virtual prop in the embodiments of this application includes the following operations.

701: Display a third game interface, the third game interface being a game setting interface corresponding to the first virtual operation object, the third game interface including a left-hand throwing option control, and the left-hand throwing option control being configured to instruct the first virtual operation object to throw a target virtual throwing prop by using the left hand in a case that the right hand is equipped with the virtual prop.

In this embodiment, to implement a left-hand throwing operation on the target virtual throwing prop by using the target virtual throwing prop selection control, that the target virtual throwing prop selection control has a function of triggering left-hand throwing of the target virtual throwing prop may be pre-configured through the setting interface.

In this case, the terminal displays the third game interface, the third game interface being the game setting interface corresponding to the first virtual operation object, the third game interface including the left-hand throwing option control, and the left-hand throwing option control being configured to instruct the first virtual operation object to throw the target virtual throwing prop by using the left hand in a case that the right hand is equipped with the virtual prop; and configures, in response to a fifth operation on the left-hand throwing option control, an operation mode of the target virtual throwing prop to be that the first virtual operation object throws the target virtual throwing prop by using the left hand in a case that the right hand is equipped with the virtual prop.

In an exemplary solution, the third game interface shown in FIG. 8 may include a plurality of setting option controls (for example, a sound setting option control and a picture quality setting option control) for a game application. A left-hand throwing option control 801 is configured to be set, as shown in FIG. 8, to be specific, to be set as a “switch option.” After the left-hand throwing option control 801 is clicked/tapped to select to be “on,” left-hand throwing may be set to be performed on a target virtual throwing prop in the game application.

702: Display a first game interface, the first game interface being configured to carry a virtual environment in which the first virtual operation object is located, the first game interface including a virtual prop selection control set, and the virtual prop selection control set including virtual prop selection controls respectively corresponding to virtual props carried by the first virtual operation object.

In this embodiment of this application, the virtual prop selection control set may include the target virtual throwing prop selection control, and the target virtual throwing prop is a virtual throwing prop carried by the first virtual operation object.

The method in this embodiment of this application is applied to the virtual environment. The virtual environment includes the first virtual operation object and the second virtual operation object. The first virtual operation object and the second virtual operation object may belong to different camps. In a possible implementation, the terminal displays the virtual environment through a virtual environment picture. In some embodiments, the virtual environment picture is a picture of observing the virtual environment from a perspective of the virtual operation object. The perspective is an observation angle for observation from a first-person perspective or a third-person perspective of the virtual operation object in the virtual environment. In some embodiments, in this embodiment of this application, the perspective is an angle for observing the virtual environment by using a camera model in the virtual environment.

In some embodiments, the camera model automatically follows the virtual operation object in the virtual environment. To be specific, when a location of the virtual operation object in the virtual environment changes, a location of the camera model following the change of the location of the virtual operation object in the virtual environment changes simultaneously, and the camera model is always within a preset distance range from the virtual operation object in the virtual environment. In some embodiments, in the automatic following process, relative locations of the camera model and the virtual operation object remain unchanged.

In this embodiment, the virtual prop selection control set is displayed on the first game interface (which may also be referred to as a virtual environment interface). The virtual prop selection control set includes the virtual prop selection controls of the virtual props carried by the first virtual operation object. The virtual prop selection control is configured to control the first virtual operation object to use the corresponding virtual prop. In this case, the virtual prop selection control includes a virtual attack prop selection control and a virtual throwing prop selection control.

In an exemplary solution, as shown in FIG. 3, the virtual prop selection control set 100 is displayed on the first game interface. The virtual prop selection control set 100 may include the virtual prop selection control 101 corresponding to the virtual prop “dagger,” the virtual prop selection control 102 corresponding to the virtual prop “gun,” and the virtual prop selection control 103 corresponding to the virtual prop “grenade.” The virtual prop selection control 101 corresponding to the virtual prop “dagger” and the virtual prop selection control 102 corresponding to the virtual prop “gun” may be referred to as virtual attack prop selection controls in this embodiment, and the virtual prop selection control 103 corresponding to the virtual prop “grenade” may be referred to as a virtual throwing prop selection control in this embodiment. The virtual attack prop selection controls and the virtual throwing prop selection control may be switched.

In an exemplary solution, as shown in FIG. 4, the virtual prop selection control set 100 is displayed on the first game interface. The virtual prop selection control set 100 may include the virtual prop selection control 101 corresponding to the virtual prop “dagger,” the virtual prop selection control 102 corresponding to the virtual prop “gun,” and the virtual prop selection control 103 corresponding to the virtual prop “grenade.” Currently, the first virtual operation object is performing a shooting action. When a player taps on the virtual prop selection control 103, the terminal may switch the virtual prop “gun” with which the first virtual operation object is equipped to the virtual prop “grenade,” and display, on the first game interface, a picture of equipping the first virtual operation object with the virtual prop “grenade.”

703: Control, in response to a second operation on the target virtual throwing prop selection control, the first virtual operation object to throw the target virtual throwing prop by using the left hand.

The target virtual throwing prop in this embodiment of this application may essentially be one of the foregoing second target virtual prop. Correspondingly, triggering the second operation on the target virtual throwing prop selection control corresponding to the target virtual throwing prop is the same as the foregoing triggering the second operation on the second target virtual prop selection control corresponding to the second target virtual prop.

In a possible implementation, when receiving the second operation on the target virtual throwing prop selection control, the terminal controls the first virtual operation object to throw the target virtual throwing prop by using the left hand. During throwing, a throwing route of the target virtual throwing prop is displayed on the first game interface. The player may cause the throwing route of the target virtual throwing prop to be changed through different trigger operations on the target virtual throwing prop selection control, to throw the target virtual throwing prop to a target location in the virtual environment.

In some embodiments, in this embodiment, if the first virtual operation object is equipped with another virtual prop on the right hand when the terminal receives the second operation, the first virtual operation object may be controlled to throw the target virtual throwing prop by using the left hand while continuously keeping the first virtual operation object equipped with the virtual prop on the right hand, and there is no need to switch the virtual prop that the first virtual operation object is equipped with on the right hand. In this solution, a principle of performing corresponding actions on both the left hand and the right hand may be as follows:

First, a template state machine needs to be established, and is referred to as the template state machine because both a left-hand animation state machine and a right-hand animation state machine directly refer to the template state machine; and then two animations, a left-hand animation and a right-hand animation, are respectively made, a full-body action state machine is responsible for playing an entire animation, and the left-hand animation state machine and the right-hand animation state machine are respectively responsible for separately playing the left-hand animation and the right-hand animation. Because each animation plays only a bone node bound to the animation, the left-hand animation state machine controls only a bone node of the left hand of the virtual operation object.

A basic idea of the state machine is to cause the virtual operation object to perform a specific action at a given moment. An action type may be different due to a different game type. A common action includes idling, walking, running, jumping, or the like. Each action is referred to as a state. Generally, a specific limit condition is required for a character to be immediately switched from a state to another state. For example, a character state can only be switched from a running state to a jumping state, but cannot be directly switched from a stationary state to a running and jumping state. The foregoing limit condition is referred to as a state transition condition. A state set, the state transition condition, and a variable recording a current state are put together to form a simplest state machine.

In some embodiments, the throwing route may be obtained based on an initial throwing speed, a throwing direction, and gravitational acceleration of the target virtual throwing prop. When the virtual operation object is controlled to throw the target virtual throwing prop, the terminal obtains the initial speed and the direction of the target virtual throwing prop, and determines a ray trace of the target virtual throwing prop by using the gravitational acceleration. The terminal takes n points according to a fixed distance interval to form the ray trace, and displays the ray trace on the first game interface. In an exemplary solution, the foregoing ray trace includes a throwing parabola from a throwing starting-point location of the target virtual throwing prop to a throwing ending-point location of the target virtual throwing prop. The foregoing throwing starting-point location of the target virtual throwing prop is a location of the target virtual throwing prop, in other words, a location at which the virtual operation object is controlled to throw the target virtual throwing prop. The throwing ending-point location of the foregoing target virtual throwing prop is a predicted landing-point location of the target virtual throwing prop. Detection may be performed on a landing point based on an area of the throwing ending-point location of the target virtual throwing prop. When an area detection result indicates that the target virtual throwing prop can reach the area, a to-be-run trace of the target virtual throwing prop is displayed as the foregoing throwing parabola. When the area detection result indicates that the target virtual throwing prop cannot reach the area, the to-be-run trace of the target virtual throwing prop is displayed as a parabola from a current location to a farthest point reachable by the target virtual throwing prop. A shape of the foregoing throwing parabola may be determined by a distance between the throwing starting-point location of the target virtual throwing prop and the throwing ending-point location of the target virtual throwing prop. In other words, the shape of the throwing parabola is variable, and an arc thereof may be negatively correlated with the foregoing distance. To be specific, the longer the distance, the smaller the arc. Apparently, the shape of the foregoing throwing parabola may also be fixed, in other words, may be a curve with a fixed arc.

In some embodiments, the virtual throwing prop is a virtual throwing prop having an active trigger function. In a possible implementation, the player may be equipped with the virtual throwing prop having the active trigger function before entering a battle. To be specific, before displaying the virtual environment interface, a virtual prop equipping interface is first displayed, and the player may select the virtual throwing prop having the active trigger function, for example, an active trigger grenade, smoke bomb, or flash bomb on the interface. In another possible implementation, the virtual throwing prop having the active trigger function may be picked up in the virtual environment after the battle is entered. The virtual throwing prop in the virtual environment may be dropped by another virtual operation object, or may be generated at a fixed location. This is not limited in this embodiment.

In a possible implementation, a prop effect of the target virtual throwing prop may be triggered through the trigger operation. When the terminal receives a trigger operation on the target virtual throwing prop, the prop effect of the target virtual throwing prop is triggered. To be specific, the player may trigger the prop effect of the target virtual throwing prop through the trigger operation, and there is no need to passively wait for the target virtual throwing prop to be triggered. In some embodiments, to simulate a picture in which an actual object controls a throwing item such as a bomb to play a role, after the player triggers the prop effect of the target virtual throwing prop, a trigger animation is displayed through the virtual operation object. For example, the virtual operation object takes out a trigger apparatus (a remote control, a mobile phone, or the like) and operates the trigger apparatus. After the operation ends, the prop effect of the target virtual throwing prop is displayed in the virtual environment picture (namely, the first game interface). In some embodiments, different virtual throwing props have different prop effects. For example, when the virtual throwing prop is a grenade, a prop effect is explosion, which may reduce a hit point of another virtual operation object; when the virtual throwing prop is a smoke bomb, a prop effect is releasing smoke, which may block a part of a view of the another virtual operation object; and when the virtual throwing prop is a flash bomb, a prop effect is strong light, which may cause a transient blinding effect on the another virtual operation object.

In an exemplary solution, the virtual throwing prop has a specified action range, causes damage or interference only to another virtual operation object within the action range, and has no impact on another virtual operation object outside the action range. Therefore, in order for the player to select a more appropriate trigger occasion, in a possible implementation, after a prop location of the virtual throwing prop is determined, the action range of the virtual throwing prop also needs to be determined. The action range may be a range with the virtual throwing prop as a center and within a fixed distance. In addition, different degrees of damage or interference at different locations within the action range may be preset. In an exemplary solution, if the target virtual throwing prop is the grenade, it is set that when a third virtual operation object exists in an explosion area of the target virtual throwing prop, a hit point of the third virtual operation object is reduced, where one or more third virtual operation objects exist, and the reduced hit point is related to a distance between the third virtual operation object and an explosion location of the target virtual throwing prop. To be specific, the closer the third virtual operation object is to the explosion location, the more hit points are reduced; and the farther the third virtual operation object is from the explosion location, the less hit points are reduced. For example, the action range of the grenade may be within 10 m from the grenade; when a distance between the virtual operation object and the explosion location of the grenade is within 3 m, the hit point is reduced by 80 points; when the distance between the virtual operation object and the explosion location of the grenade is greater than 3 m and less than 6 m, the hit point is reduced by 50 points; and when the distance between the virtual operation object and the explosion location of the grenade is greater than 6 m and less than 10 m, the hit point is reduced by 20 points.

In this embodiment, to determine the location of the target virtual throwing prop, in a possible implementation, when the target virtual throwing prop is in a flying state, the terminal performs ray detection within a preset distance in a ray trace direction of the target virtual throwing prop, and determines a virtual environment object (for example, an apparatus such as a vehicle, a wall, or a stone) in the ray trace direction. For example, the preset distance may be 50 cm. Then, when the virtual environment object exists in a range of the ray detection, whether the virtual environment object collides with the target virtual throwing prop is determined; and if the virtual environment object collides with the target virtual throwing prop, a collision effect between the target virtual throwing prop and the virtual environment object is simulated, and the throwing route of the target virtual throwing prop is changed.

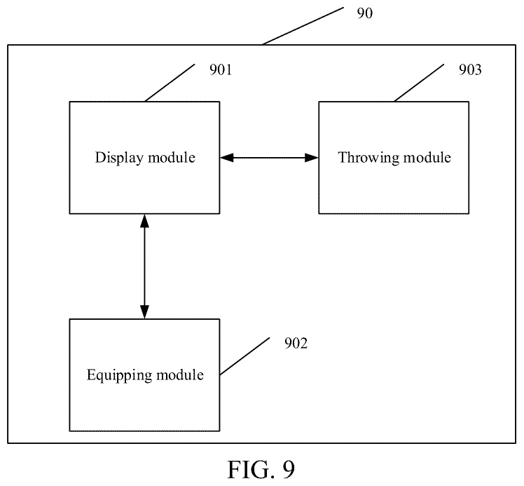

An apparatus for controlling a virtual prop in this application is described below in detail. FIG. 9 is a schematic diagram showing an embodiment of an apparatus for controlling a virtual prop according to an embodiment of this application. An apparatus 90 for controlling a virtual prop includes:
a display module 901, configured to display a first game interface, the first game interface being configured to carry a virtual environment in which a first virtual operation object is located, the first game interface including a virtual prop selection control set, and the virtual prop selection control set including virtual prop selection controls respectively corresponding to virtual props carried by the first virtual operation object;
an equipping module 902, configured to control, in response to a first operation on a first target virtual prop selection control in the virtual prop selection control set, the first virtual operation object to be equipped with a first target virtual prop corresponding to the first target virtual prop selection control; and
a throwing module 903, configured to control, in response to a second operation on a second target virtual prop selection control in the virtual prop selection control set, the first virtual operation object to throw a second target virtual prop corresponding to the second target virtual prop selection control, an equipping operation on the first target virtual prop and a throwing operation on the second target virtual prop being implemented by using different parts of the first virtual operation object.

In this embodiment of this application, the apparatus for controlling a virtual prop is provided. By using the foregoing apparatus, the virtual control object is supported in controlling the virtual prop by using different parts of the virtual control object. In this way, a manner for controlling the virtual prop is enriched. To be specific, the manner for controlling the virtual prop is no longer limited to controlling the virtual prop by using a right hand of the virtual operation object, and the virtual prop may alternatively be controlled by using another part (for example, a left hand) of the virtual operation object. In addition, in a case that the manner for controlling the virtual prop is no longer limited to controlling the virtual prop by using the right hand of the virtual operation object, the user may directly control another virtual prop by using another part of the virtual operation object without performing a switching operation on the virtual prop. For example, in a case that the virtual operation object holds a virtual attack prop on the right hand, the user may control the virtual operation object to throw another virtual prop by using the left hand of the virtual operation object, thereby reducing time consumption of a related operation.

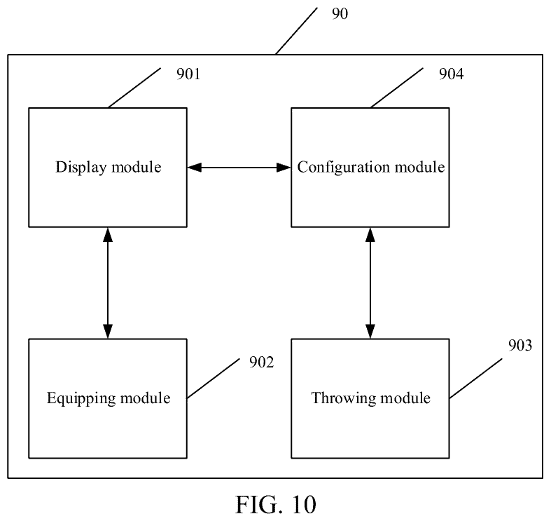

In some embodiments, based on the embodiment corresponding to FIG. 9, in another embodiment of the apparatus 90 for controlling a virtual prop provided in the embodiments of this application, when the first target virtual prop and the second target virtual prop are a same target virtual prop, as shown in FIG. 10, the display module 901 is further configured to display a second game interface, the second game interface being a virtual prop setting interface corresponding to the first virtual operation object, the second game interface including an operation mode option control, and the operation mode option control being configured to indicate that the first virtual operation object has a left-hand throwing operation mode and a right-hand equipping mode for the target virtual prop; and
the control apparatus further includes a configuration module 904, and the configuration module 904 is configured to configure, in response to a third operation on the operation mode option control, an operation mode of the target virtual prop to be the left-hand throwing operation mode and the right-hand equipping mode.

In this embodiment of this application, the apparatus for controlling a virtual prop is provided. By using the foregoing apparatus, the operation mode of the target virtual prop during a game is changed by using the operation mode option control, so that the operation mode of the target virtual prop is increased from a single operation mode to two switchable operation modes, thereby enriching the operation mode of the target virtual prop, and further improving game playability.

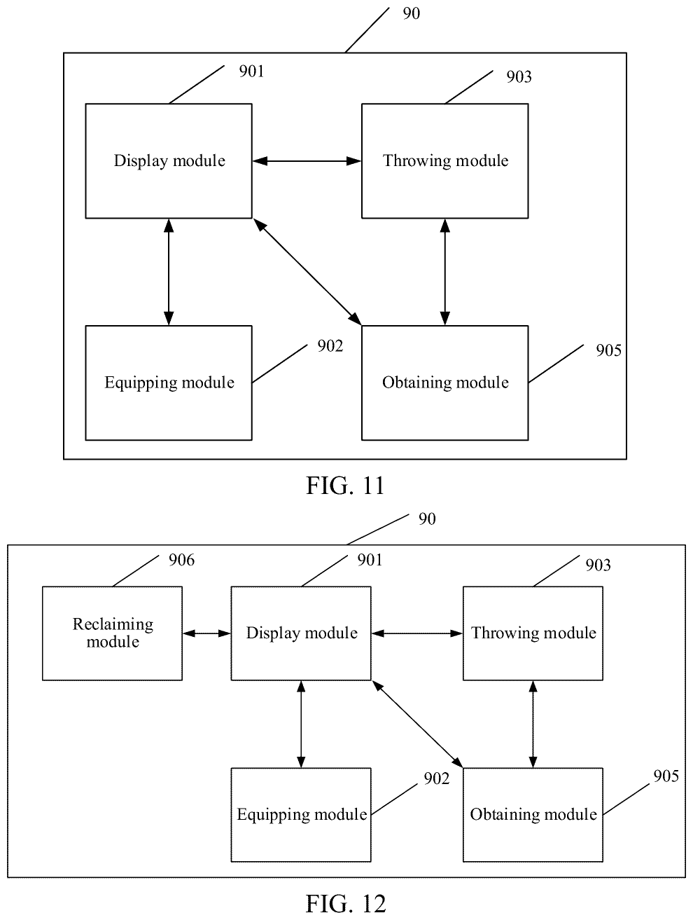

In some embodiments, based on the embodiment corresponding to FIG. 9, in another embodiment of the apparatus 90 for controlling a virtual prop provided in the embodiments of this application, as shown in FIG. 11, the control apparatus further includes an obtaining module 905. The obtaining module 905 is configured to obtain a first prop location and a first throwing parabola of the second target virtual prop in the virtual environment after throwing.

The display module 901 is further configured to display the first throwing parabola on the first game interface, and display a prop identifier of the second target virtual prop on the first game interface based on the first prop location.

In this embodiment of this application, the apparatus for controlling a virtual prop is provided. By using the foregoing apparatus, a throwing location and a throwing route of the second target virtual prop are displayed, so that a player may obtain a throwing effect of the second target virtual prop more intuitively, thereby improving game playability.

In some embodiments, based on the embodiment corresponding to FIG. 11, in another embodiment of the apparatus 90 for controlling a virtual prop provided in the embodiments of this application, as shown in FIG. 12, the control apparatus further includes a reclaiming module 906, configured to control, in response to a fourth operation on the prop identifier, the first virtual operation object to reclaim the second target virtual prop.

In this embodiment of this application, the apparatus for controlling a virtual prop is provided. By using the foregoing apparatus, it is ensured that the second target virtual prop is reclaimable, so that the second target virtual prop may be used for a plurality of times, thereby improving game playability.

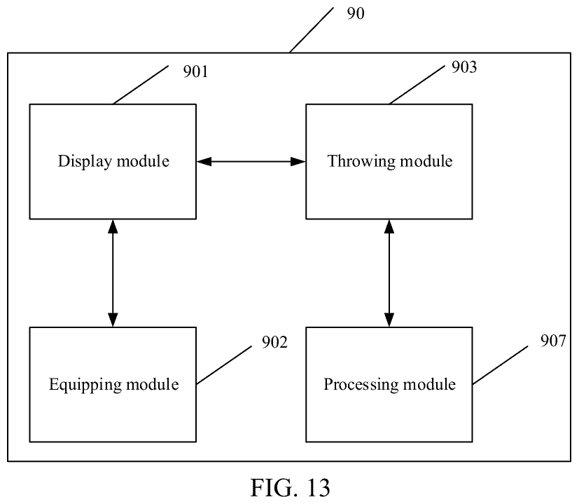

In some embodiments, based on the embodiment corresponding to FIG. 9, in another embodiment of the apparatus 90 for controlling a virtual prop provided in the embodiments of this application, as shown in FIG. 13, the control apparatus further includes a processing module 907. The processing module 907 is configured to: reduce, when the second target virtual prop hits a second virtual operation object, a hit point of the second virtual operation object, the reduced hit point being related to a hit location of the second target virtual prop on the second virtual operation object;
or
zero, when the second target virtual prop hits a second virtual operation object, a hit point of the second virtual operation object.

In this embodiment of this application, the apparatus for controlling a virtual prop is provided. By using the foregoing apparatus, an attack effect of the second target virtual prop is displayed through an intuitive game picture, thereby improving game experience of a game player.

In some embodiments, based on the embodiment corresponding to FIG. 9, in another embodiment of the apparatus 90 for controlling a virtual prop provided in the embodiments of this application, the throwing module 903 is specifically configured to control the first virtual operation object to throw the second target virtual prop by using a left hand in a case that a right hand is equipped with a virtual prop;
or
the throwing module 903 is specifically configured to control the first virtual operation object to throw the second target virtual prop by using a right hand in a case that a left hand is equipped with a virtual prop.

In this embodiment of this application, the apparatus for controlling a virtual prop is provided. By using the foregoing apparatus, when the first virtual operation object uses a throwing mode on the target virtual prop, the first virtual operation object can also be equipped with another prop on the right hand. In this way, a process of prop switching can be reduced, and prop operation efficiency can be improved.

In some embodiments, based on the foregoing embodiment corresponding to FIG. 9, in another embodiment of the apparatus 90 for controlling a virtual prop provided in the embodiments of this application, the first operation is any one of a single-click/tap operation, a double-click/tap operation, a sliding operation, and a long-press operation; and
the second operation is any one of a single-click/tap operation, a double-click/tap operation, a sliding operation, and a long-press operation.

In this embodiment of this application, the apparatus for controlling a virtual prop is provided. By using the foregoing apparatus, a plurality of operation manners are provided, and solution implementability can be improved.

In some embodiments, based on the embodiment corresponding to FIG. 9, in another embodiment of the apparatus 90 for controlling a virtual prop provided in the embodiments of this application, as shown in FIG. 10, the display module 901 is further configured to display a third game interface, the third game interface being a game setting interface corresponding to the first virtual operation object, the third game interface including a left-hand throwing option control, and the left-hand throwing option control being configured to instruct the first virtual operation object to throw a target virtual throwing prop by using the left hand in a case that the right hand is equipped with the virtual prop; and
the configuration module 904 is further configured to configure, in response to a fifth operation on the left-hand throwing option control, the target virtual throwing prop to have a left-hand throwing function.

In this embodiment of this application, the apparatus for controlling a virtual prop is provided. By using the foregoing apparatus, in a case that the right hand is equipped with the prop, a left-hand throwing mode of the target virtual throwing prop is added. In this way, a process of prop switching can be reduced and prop operation efficiency can be improved.

In some embodiments, based on the embodiment corresponding to FIG. 10, in another embodiment of the apparatus 90 for controlling a virtual prop provided in the embodiments of this application, the throwing module 903 is further configured to control, in response to a second operation on a target virtual throwing prop selection control in the virtual prop selection control set, the first virtual operation object to throw the target virtual throwing prop by using the left hand.

In this embodiment of this application, the apparatus for controlling a virtual prop is provided. By using the foregoing apparatus, in a case that the right hand is equipped with the prop, the left-hand throwing mode of the target virtual throwing prop is added. In this way, the process of prop switching can be reduced and the prop operation efficiency can be improved.

In some embodiments, based on the embodiment corresponding to FIG. 11, in another embodiment of the apparatus 90 for controlling a virtual prop provided in the embodiments of this application, the obtaining module 905 is further configured to obtain a second prop location and a second throwing parabola of the target virtual throwing prop in the virtual environment after throwing.

The display module 901 is further configured to display the second throwing parabola on the first game interface, and display a target throwing location of the target virtual throwing prop on the first game interface based on the second prop location.

In this embodiment of this application, the apparatus for controlling a virtual prop is provided. By using the foregoing apparatus, a throwing location and a throwing route of the target virtual throwing prop are displayed, so that the player may obtain a throwing effect of the target virtual throwing prop more intuitively, thereby improving game playability.

In some embodiments, based on the embodiment corresponding to FIG. 13, in another embodiment of the apparatus 90 for controlling a virtual prop provided in the embodiments of this application, the processing module 907 is further configured to reduce, when a third virtual operation object exists within an action range of the target virtual throwing prop, a hit point of the third virtual operation object, one or more third virtual operation object existing, and the reduced hit point being related to a distance between the third virtual operation object and a target throwing location of the target virtual throwing prop.

In this embodiment of this application, the apparatus for controlling a virtual prop is provided. By using the foregoing apparatus, an attack effect of the target virtual throwing prop is displayed through an intuitive game picture, thereby improving game experience of a game player.

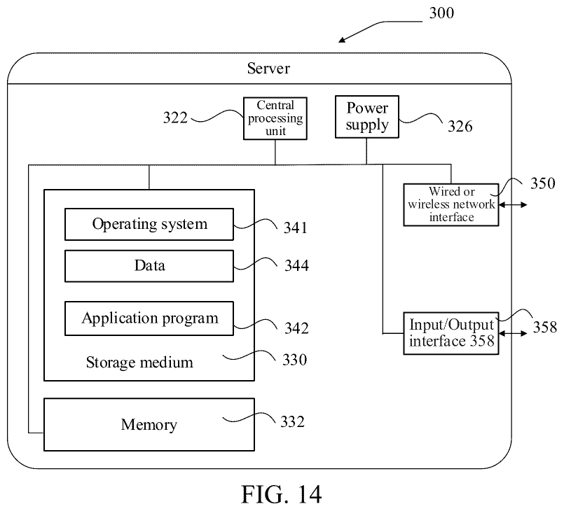

The apparatus for controlling a virtual prop provided in this application may be used in a server. FIG. 14 is a schematic structural diagram of a server according to an embodiment of this application. A server 300 may vary greatly due to different configurations or performance, and may include one or more central processing units (CPU) 322 (for example, one or more processors) and a memory 332, and one or more storage medium 330 (for example, one or more mass storage devices) that store an application program 342 or data 344. The memory 332 and the storage medium 330 may be transient or persistent storages. The program stored in the storage medium 330 may include one or more modules (not marked in the figure), and each module may include a series of instruction operations to the server. Furthermore, the central processing unit 322 may be configured to communicate with the storage medium 330, and perform, on the server 300, the series of instruction operations in the storage medium 330.

The server 300 may further include one or more power supplies 326, one or more wired or wireless network interfaces 350, one or more input/output interfaces 358, and/or one or more operating systems 341, for example, Windows Server™, Mac OS X™, Unix™, Linux™, and FreeBSD™.

The operations performed in the foregoing embodiments may be based on a structure of the server shown in FIG. 14.

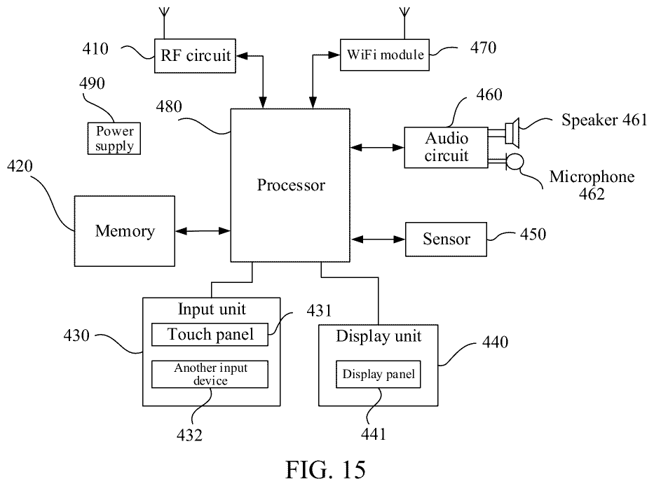

The apparatus for controlling a virtual prop provided in this application may be used in a terminal device. Referring to FIG. 15, for ease of description, only a part related to this embodiment of this application is shown. For a specific technical detail not disclosed, refer to the method part in the embodiments of this application. In the embodiments of this application, description is provided in an example in which the terminal device is a smartphone.

FIG. 15 is a block diagram showing a structure of a part of a smartphone related to a terminal device according to an embodiment of this application. Referring to FIG. 15, the smartphone includes components such as: a radio frequency (RF) circuit 410, a memory 420, an input unit 430, a display unit 440, a sensor 450, an audio circuit 460, a wireless fidelity (Wi-Fi) module 470, a processor 480, and a power supply 490. A person skilled in the art may understand that the structure of the smartphone shown in FIG. 15 does not constitute a limitation on the smartphone, and the smartphone may include more components or fewer components than those shown in the figure, or some components may be combined, or a different component deployment may be used.

The following makes a detailed description of the components of the smartphone with reference to FIG. 15.

The RF circuit 410 may be configured to receive and send a signal in an information receiving and sending process or a call process, and in particular, after downlink information of a base station is received, send the downlink information to the processor 480 for processing. In addition, the RF circuit transmits uplink data to the base station. Generally, the RF circuit 410 includes, but is not limited to, an antenna, at least one amplifier, a transceiver, a coupler, a low noise amplifier (LNA), a duplexer, and the like. In addition, the RF circuit 410 may also communicate with a network and another device through wireless communication. The wireless communication may use any communication standard or protocol, including, but not limited to, global system for mobile communication (GSM), general packet radio service (GPRS), code division multiple access (CDMA), wideband code division multiple access (WCDMA), long term evolution (LTE), email, short messaging service (SMS), and the like.

The memory 420 may be configured to store a software program and module. The processor 480 runs the software program and module stored in the memory 420, to implement various functional applications and data processing of the smartphone. The memory 420 may mainly include a program storage area and a data storage area. The program storage area may store an operating system, an application program required by at least one function (for example, a sound playing function and an image playing function), and the like. The data storage area may store data (for example, audio data and a phone book) created according to use of the smartphone. In addition, the memory 420 may include a high speed random-access memory, and may further include a non-volatile memory, such as at least one magnetic disk storage device, a flash memory, or another volatile solid storage device.

The input unit 430 may be configured to receive inputted digit or character information, and generate a keyboard signal input related to the user setting and function control of the smartphone. Specifically, the input unit 430 may include a touch panel 431 and another input device 432. The touch panel 431, also referred to as a touch screen, may collect a touch operation of a user on or near the touch panel (such as an operation of the user on or near the touch panel 431 by using any suitable object or accessory such as a finger or a stylus), and drive a corresponding connection apparatus according to a preset program. In some embodiments, the touch panel 431 may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts the touch information into contact coordinates, then transmits the contact coordinates to the processor 480, and receives and executes a command transmitted by the processor 480. In addition, the touch panel 431 may be implemented by using various types, such as a resistive type, a capacitive type, an infrared type, and a surface acoustic wave type. In addition to the touch panel 431, the input unit 430 may further include the another input device 432. Specifically, the another input device 432 may include, but not limited to, one or more of a physical keyboard, a functional key (such as a volume control key or a switch key), a track ball, a mouse, and a joystick.

The display unit 440 may be configured to display information inputted by the user or information provided for the user, and various menus of the smartphone. The display unit 440 may include a display panel 441. In some embodiments, the display panel 441 may be configured by using a liquid crystal display (LCD), an organic light-emitting diode (OLED), or the like. Further, the touch panel 431 may cover the display panel 441. After detecting a touch operation on or near the touch panel, the touch panel 431 transfers the touch operation to the processor 480, to determine a type of a touch event. Then, the processor 480 provides a corresponding visual output on the display panel 441 according to the type of the touch event. Although in FIG. 15, the touch panel 431 and the display panel 441 are used as two independent parts, to implement input and output functions of the smartphone, in some embodiments, the touch panel 431 and the display panel 441 may be integrated to implement the input and output functions of the smartphone.

The smartphone may further include at least one sensor 450 such as an optical sensor, a motion sensor, and another sensor. Specifically, the optical sensor may include an ambient light sensor and a proximity sensor. The ambient light sensor may adjust luminance of the display panel 441 according to brightness of the ambient light. The proximity sensor may switch off the display panel 441 and/or backlight when the smartphone is moved to the car. As one type of motion sensor, an acceleration sensor can detect magnitude of accelerations in various directions (generally on three axes), may detect magnitude and a direction of the gravity when being static, and may be applied to an application that recognizes the attitude of the smartphone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the smartphone, are not further described herein.

The audio circuit 460, a speaker 461, and a microphone 462 may provide audio interfaces between the user and the smartphone. The audio circuit 460 may transmit, to the loudspeaker 461, an electrical signal obtained by converting received audio data, and the loudspeaker 461 converts the electrical signal into a voice signal for outputting. In addition, the microphone 462 converts a collected sound signal into an electrical signal. After receiving the electrical signal, the audio circuit 460 converts the electrical signal into audio data, and then outputs the audio data. After processed by the processor 480, the audio data is transmitted through the RF circuit 410 to, for example, another smartphone or the audio data is outputted to the memory 420 for further processing.

Wi-Fi is a short distance wireless transmission technology. The smartphone may help, by using a Wi-Fi module 470, a user to send and receive an email, browse a web page, access stream media, and the like. This provides wireless broadband Internet access for the user. Although FIG. 15 shows the Wi-Fi module 470, the Wi-Fi module is not a necessary component of the smartphone, and when required, the Wi-Fi module may be omitted as long as the scope of the essence of the present invention is not changed.

The processor 480 is a control center of the smartphone, and is connected to various parts of the entire smartphone by using various interfaces and lines. By running or executing the software program and/or the module stored in the memory 420, and invoking data stored in the memory 420, the processor executes various functions of the smartphone and performs data processing, thereby monitoring the entire smartphone. In some embodiments, the processor 480 may include one or more processing units. In some embodiments, the processor 480 may integrate an application processor and a modem. The application processor mainly processes an operating system, a user interface, an application program, and the like. The modem mainly processes wireless communication. The modem processor may either not be integrated into the processor 480.

The smartphone further includes the power supply 490 (such as a battery) for supplying power to the components. In some embodiments, the power supply may be logically connected to the processor 480 by using a power management system, thereby implementing functions such as charging, discharging and power consumption management by using the power management system.

Although not shown in the figure, the smartphone may further include a camera, a Bluetooth module, and the like. Details are not described herein again.

The operations performed by the terminal device in the foregoing embodiments may be based on the structure of the terminal device shown in FIG. 15.

An embodiment of this application further provides a computer-readable storage medium, storing a computer program, the computer program, when run on a computer, causing the computer to perform the method described in the foregoing embodiments.

An embodiment of this application further provides a computer program product including a program, the program, when run on a computer, causing the computer to perform the method described in the foregoing embodiments.

A person skilled in the art may clearly understand that, for the purpose of convenient and brief description, for a detailed working process of the system, apparatus, and unit described above, refer to a corresponding process in the method embodiments, and details are not described herein again.

In the several embodiments provided in this application, the disclosed system, apparatus, and method may be implemented in other manners. For example, the described apparatus embodiments are only exemplary. For example, the division of the units is only a logical function division and may be other divisions during actual implementation. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate. Parts displayed as units may or may not be physical units, and may be located in one position, or may be distributed on a plurality of network units. Some or all of the units may be selected according to an actual requirement to achieve the objectives of the solutions in the embodiments.

In addition, functional units in the embodiments of this application may be integrated into one processing unit, or each of the units may exist alone physically, or two or more units are integrated into one unit. The integrated unit may be implemented in the form of hardware, or may be implemented in the form of a software function unit.

When the integrated unit is implemented in the form of a software functional unit and sold or used as an independent product, the integrated unit may be stored in a computer-readable storage medium. Based on such an understanding, the technical solutions of this application essentially, or all or a part of the technical solutions may be implemented in the form of a software product. The computer software product is stored in a storage medium and includes several instructions for instructing a computer device (which may be a personal computer, a server, or a network device) to perform all or some of the operations of the method described in the embodiments of this application. The foregoing storage medium comprises: any medium that can store program code, such as a USB flash drive, a removable hard disk, a read-only memory (ROM), a RAM, a magnetic disk, a compact disc, or the like.

The foregoing embodiments are merely intended for describing the technical solutions of this application, but not for limiting this application. It is to be understood by a person of ordinary skill in the art that although this application has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the technical solutions of the embodiments of this application.

What is claimed is:

1. A control method, performed by a terminal, the method comprising:
displaying a game interface, the game interface being configured to carry a virtual environment in which a virtual operation object is located, and the game interface including a virtual prop selection control set;
controlling, in response to a first operation on a first target virtual prop selection control in the virtual prop selection control set, the virtual operation object to be equipped with a first target virtual prop corresponding to the first target virtual prop selection control; and
controlling, in response to a second operation on a second target virtual prop selection control in the virtual prop selection control set, the virtual operation object to throw a second target virtual prop corresponding to the second target virtual prop selection control;
wherein an equipping operation on the first target virtual prop and a throwing operation on the second target virtual prop are implemented using different parts of the virtual operation object.

2. The method according to claim 1,
wherein:
the game interface is a first game interface; and
the first target virtual prop is same as the second target virtual prop;
the method further comprising:
displaying a second game interface, the second game interface being a virtual prop setting interface corresponding to the virtual operation object, the second game interface including an operation mode option control, and the operation mode option control being configured to indicate that the virtual operation object has a left-hand throwing operation mode and a right-hand equipping mode for the target virtual prop; and
configuring, in response to a third operation on the operation mode option control, an operation mode of the target virtual prop to be the left-hand throwing operation mode and the right-hand equipping mode.

3. The method according to claim 1, further comprising, after controlling the virtual operation object to throw the second target virtual prop:
obtaining a prop location and a throwing parabola of the second target virtual prop in the virtual environment;
displaying the throwing parabola on the game interface; and
displaying a prop identifier of the second target virtual prop on the game interface based on the prop location.

4. The method according to claim 3, further comprising:
controlling, in response to a third operation on the prop identifier, the virtual operation object to reclaim the second target virtual prop.

5. The method according to claim 1,
wherein the virtual operation object is a first virtual operation object;
the method further comprising, after controlling the virtual operation object to throw the second target virtual prop:
reducing, in response to the second target virtual prop hitting a second virtual operation object, a hit point of the second virtual operation object by an amount related to a hit location of the second target virtual prop on the second virtual operation object.

6. The method according to claim 1,
wherein the virtual operation object is a first virtual operation object;
the method further comprising, after controlling the virtual operation object to throw the second target virtual prop:
zeroing, in response to the second target virtual prop hitting a second virtual operation object, a hit point of the second virtual operation object.

7. The method according to claim 1, wherein controlling the virtual operation object to throw the second target virtual prop includes:
controlling the virtual operation object to throw the second target virtual prop using a left hand of the virtual operation object in a case that a right hand of the virtual operation object is equipped with a virtual prop.

8. The method according to claim 1, wherein controlling the virtual operation object to throw the second target virtual prop includes:
controlling the virtual operation object to throw the second target virtual prop using a right hand of the virtual operation object in a case that a left hand of the virtual operation object is equipped with a virtual prop.

9. The method according to claim 1, wherein:
the first operation is any one of a single-click/tap operation, a double-click/tap operation, a sliding operation, and a long-press operation; and
the second operation is any one of a single-click/tap operation, a double-click/tap operation, a sliding operation, and a long-press operation.

10. The method according to claim 1,
wherein the game interface is a first game interface;
the method further comprising:
displaying a second game interface, the second game interface being a game setting interface corresponding to the virtual operation object, the second game interface including a left-hand throwing option control, and the left-hand throwing option control being configured to instruct the virtual operation object to throw a target virtual throwing prop using a left hand of the virtual operation object in a case that a right hand of the virtual operation object is equipped with a virtual prop; and
configuring, in response to a third operation on the left-hand throwing option control, the target virtual throwing prop to have a left-hand throwing function.

11. The method according to claim 10, wherein controlling, in response to the second operation on the second target virtual prop selection control in the virtual prop selection control set, the virtual operation object to throw the second target virtual prop includes:
controlling, in response to the second operation on a target virtual throwing prop selection control in the virtual prop selection control set, the virtual operation object to throw the target virtual throwing prop using the left hand.

12. The method according to claim 11, further comprising, after controlling the virtual operation object to throw the target virtual throwing prop:
obtaining a prop location and a throwing parabola of the target virtual throwing prop in the virtual environment;
displaying the throwing parabola on the first game interface; and
displaying a target throwing location of the target virtual throwing prop on the first game interface based on the prop location.

13. The method according to claim 11,
wherein the virtual operation object is a first virtual operation object;
the method further comprising, after controlling the virtual operation object to throw the target virtual throwing prop:
reducing, in response to one or more second virtual operation objects existing within an action range of the target virtual throwing prop, a hit point of each of the one or more second virtual operation objects by an amount related to a distance between the second virtual operation object and a target throwing location of the target virtual throwing prop.

14. A computer device comprising:
at least one bus system;
at least one memory storing one or more programs; and
at least one processor connected to and communicating with the at least one memory through the at least one bus system, and configured to execute the one or more programs to:
display a game interface, the game interface being configured to carry a virtual environment in which a virtual operation object is located, and the game interface including a virtual prop selection control set;
control, in response to a first operation on a first target virtual prop selection control in the virtual prop selection control set, the virtual operation object to be equipped with a first target virtual prop corresponding to the first target virtual prop selection control; and
control, in response to a second operation on a second target virtual prop selection control in the virtual prop selection control set, the virtual operation object to throw a second target virtual prop corresponding to the second target virtual prop selection control;
wherein an equipping operation on the first target virtual prop and a throwing operation on the second target virtual prop are implemented using different parts of the virtual operation object.

15. The computer device according to claim 14, wherein:
the game interface is a first game interface;
the first target virtual prop is same as the second target virtual prop;
the at least one processor is further configured to execute the one or more programs to:
display a second game interface, the second game interface being a virtual prop setting interface corresponding to the virtual operation object, the second game interface including an operation mode option control, and the operation mode option control being configured to indicate that the virtual operation object has a left-hand throwing operation mode and a right-hand equipping mode for the target virtual prop; and
configure, in response to a third operation on the operation mode option control, an operation mode of the target virtual prop to be the left-hand throwing operation mode and the right-hand equipping mode.

16. The computer device according to claim 14, wherein the at least one processor is further configured to execute the one or more programs to, after controlling the virtual operation object to throw the second target virtual prop:
obtain a prop location and a throwing parabola of the second target virtual prop in the virtual environment;
display the throwing parabola on the game interface; and
display a prop identifier of the second target virtual prop on the game interface based on the prop location.

17. The computer device according to claim 16, wherein the at least one processor is further configured to execute the one or more programs to:
control, in response to a third operation on the prop identifier, the virtual operation object to reclaim the second target virtual prop.

18. The computer device according to claim 14, wherein:
the virtual operation object is a first virtual operation object; and
the at least one processor is further configured to execute the one or more programs to, after controlling the virtual operation object to throw the second target virtual prop:
reduce, in response to the second target virtual prop hitting a second virtual operation object, a hit point of the second virtual operation object by an amount related to a hit location of the second target virtual prop on the second virtual operation object.

19. The computer device according to claim 14, wherein:
the virtual operation object is a first virtual operation object;
the at least one processor is further configured to execute the one or more programs to, after controlling the virtual operation object to throw the second target virtual prop:
zero, in response to the second target virtual prop hitting a second virtual operation object, a hit point of the second virtual operation object.

20. A non-transitory computer-readable storage medium storing one or more instructions that, when run on a computer, cause the computer to:
display a game interface, the game interface being configured to carry a virtual environment in which a virtual operation object is located, and the game interface including a virtual prop selection control set;
control, in response to a first operation on a first target virtual prop selection control in the virtual prop selection control set, the virtual operation object to be equipped with a first target virtual prop corresponding to the first target virtual prop selection control; and
control, in response to a second operation on a second target virtual prop selection control in the virtual prop selection control set, the virtual operation object to throw a second target virtual prop corresponding to the second target virtual prop selection control;
wherein an equipping operation on the first target virtual prop and a throwing operation on the second target virtual prop are implemented using different parts of the virtual operation object.
